(19) United States
(12) Patent Application Publication
(10) Pub. No.: US 2004/0050228 A1
(43) Pub. Date: Mar. 18, 2004

(54) Mandrel rod with internal support rollers

(76) Inventor: John J. Borzym, Northville, MI (US)

Correspondence Address: Thomas N. Young, YOUNG & BASILE, Suite 624, 3001 West Big Beaver Road, Troy, MI, 48084-3107, US

(21) Appl. No.: 10/245,192

(22) Filed: Sep. 16, 2002

(51) Int. Cl. B23D 21/14

(52) U.S. Cl. 83/178; 83/180

(57) ABSTRACT

A mandrel support is held along the centerline of a tube being processed by one or more forms attached to the rod at spaced points. Each form includes rubber rollers providing for low-friction movement of the tube thereover. The tube rests on a table comprising two parallel round steel bars which can be variably spaced apart.

### FIELD OF THE INVENTION

This invention relates to apparatus for feeding tubing over a mandrel support rod which extends through the interior of the tubing to a processing station such as a shear. More particularly the invention relates to the provision of support bodies located at one or more points along the mandrel rod which support bodies carry rollers to provide a low friction engagement with the interior surface of the tubing.

### BACKGROUND OF THE INVENTION

U.S. Pat. No. 6,123,003 “Automatic Feed System for Supported Shear Device and Methods of Operating Same” illustrates and describes a system for feeding lengths of steel tubing into a shearing apparatus which may be of the type described in U.S. Pat. No. 6,352,012 issued Mar. 5, 2002. The nature of the shearing apparatus is such as to require internal tooling in the form of a mandrel located in the shear plane area. To precisely locate the mandrel relative to the shear plane, the mandrel is connected to a support rod which extends along a path between a tube entry point and the shear plane.

Because the mandrel rod may be 20 or more feet long and made of relatively small diameter steel stock, it tends to sag relative to the tube centerline unless support is provided at one or more midpoints. The '003 patent discloses the use of forms 48 and 50 located at spaced midpoints along the mandrel rod and conforming substantially to the inside surface configuration of the tubing. The mandrel rod support forms maintain the mandrel rod essentially along the centerline of the tube as it is fed into the shear station. In the disclosed embodiment, the mandrel rod forms work in combination with a tube support table comprising a pair of spaced apart parallel steel rods or bars. In essence, the table supports the tube and the tube supports the forms and the mandrel rod.

It has been found that the support forms create friction which adds to the power required from the feed system, the greater the number of forms, the greater the friction.

### SUMMARY OF THE INVENTION

The present invention has for its principal objective the provision of an improved support form for use in combination with a mandrel rod to substantially reduce the friction between the mandrel rod support forms and the tubing being fed thereover. In general this is accomplished by providing the support form with one or more rollers, the axes of rotation of which are perpendicular to the tube centerline and tube travel axis.

In the preferred embodiment hereinafter illustrated and described, each support form includes a body mechanically connected into the rod to provide mounting locations for rollers the axes of rotation of which are perpendicular to the longitudinal axis of the mandrel rod. The rollers are axially and angularly spaced apart and are preferably made of hard rubber or other equivalent resilient and durable material. The roller axles are offset relative to the centerline of the tube so each roller contacts the inside surface of the tube at only one point. Where three rollers are used, the contact points are spaced about 120° apart.

As hereinafter described in greater detail, the mandrel rod and roller support forms work well in combination with a tube support table of the type described and illustrated in FIGS. 9A, 9B and 10 of U.S. Pat. No. 6,352,012 in which I am a co-inventor. That tube support comprises a pair of spaced apart steel bars with round cross-sections so as to contact the outside surface of the tubing at just two tangential contact points. The bars of the support can be adjusted in spacing to accommodate tubing of different diameters.

### BRIEF DESCRIPTION OF THE DRAWINGS

The description herein makes reference to the accompanying drawings wherein like reference numerals refer to like parts throughout the several views, and wherein:

FIG. 1 is a perspective view of a tubing recut apparatus employing the invention;

FIG. 2 is a detailed cross-sectional view of a complete mandrel rod with one form of embodying the invention;

FIG. 3 is a perspective view of a support form embodying the invention;

FIG. 4 is a cross-sectional end view of a tube with a support form internally thereof and resting on a table; and

FIG. 5 is a perspective view of a portion of the tube support table.

### DETAILED DESCRIPTION OF THE PREFERRED EMBODIMENT

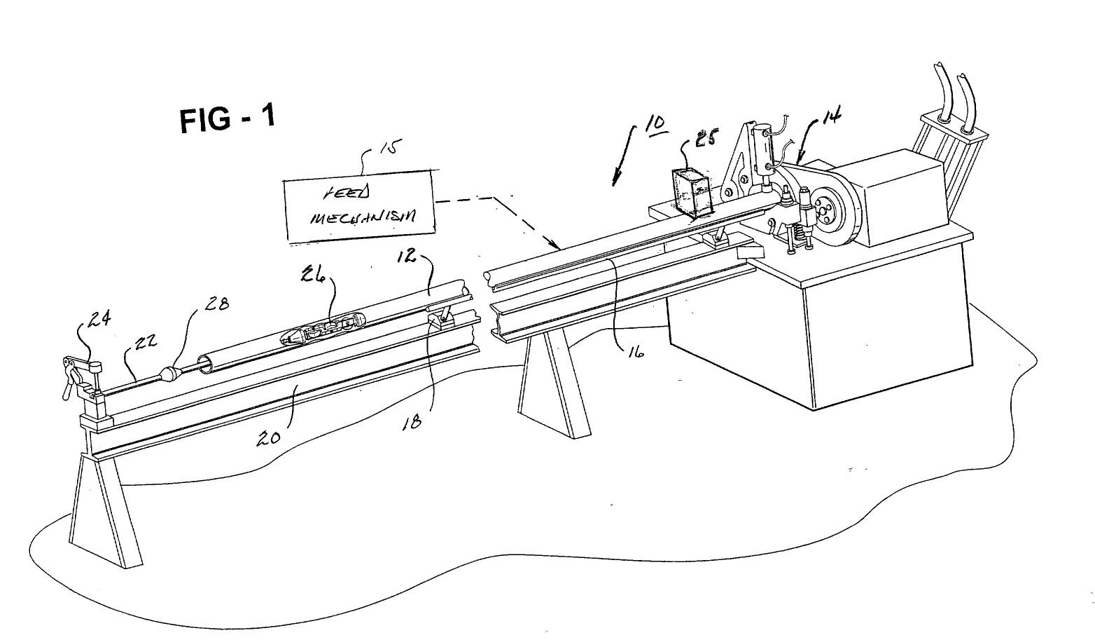

Referring to FIG. 1 the preferred embodiment of the invention is incorporated into an apparatus 10 for feeding steel tubing 12 to a supported shear 14 by a drive mechanism 15. As it is being fed to the shear 14 the tubing 12 slides along a support table comprising spaced apart parallel steel bars 16 supported by blocks 18 on an I-beam 20. Tubing 12 passes over and encloses a mandrel rod 22 having a number of axially spaced apart support forms 26 and 28.

Details of the apparatus 10, inclusive of the drive 15 but exclusive of the novel support form 26 hereinafter described, can be found in U.S. Pat. No. 6,123,003 issued Sep. 26, 2000 the disclosure of which is incorporated herein by reference. As described in the '003 patent, the mandrel rod 22 is held in position by independently operable locks 24 and 25; lock 24 is near the tube entry point for the feed system, whereas lock 25 is closer to the shear 14. The locks 24, 25 are farther apart than the maximum length of tube 10.

In the present embodiment the mandrel support rod 22 is provided with one or more low friction roller-type support forms 26 over which the tubing 12 passes on its way from the entry lock 24 to the shear 14. The mandrel rod 22 may further include one or more conventional support forms 28 as shown.

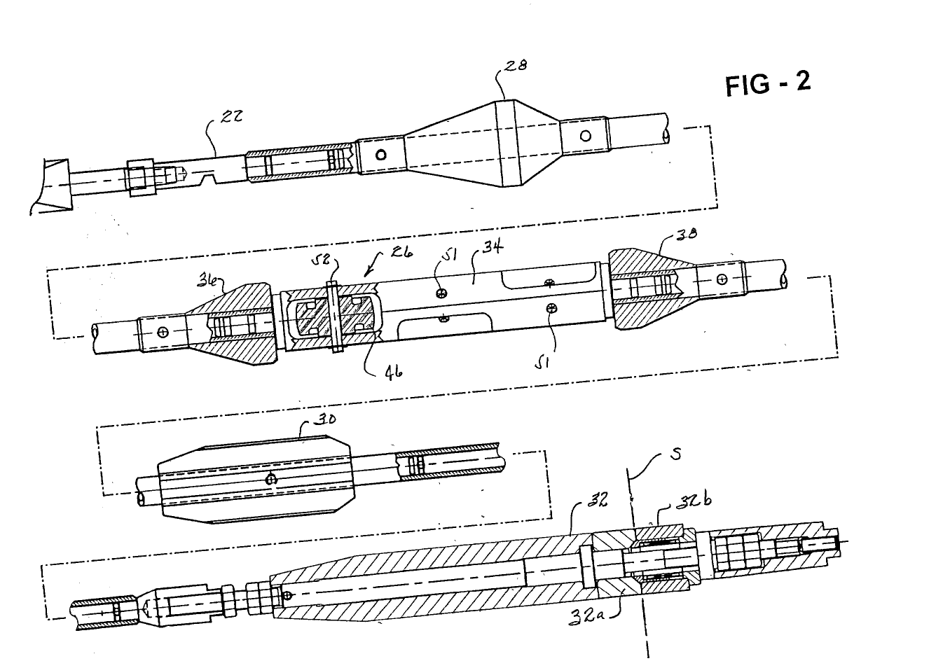

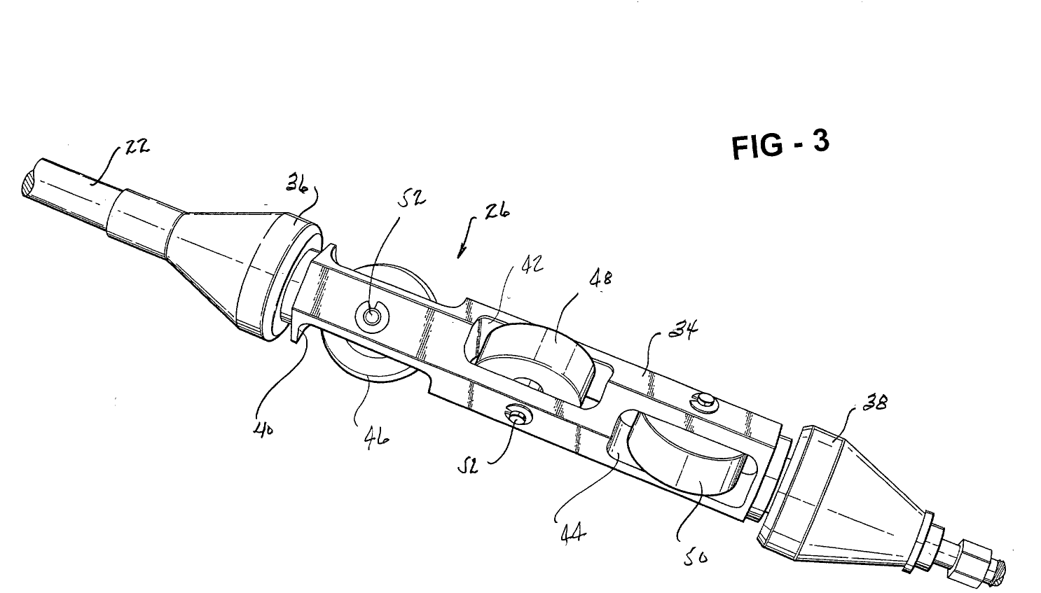

Referring now to FIGS. 2 and 3 the details of the mandrel rod assembly and the roller support form 26 will be described in detail.

The mandrel rod 22, although it may be hollow or solid stock, is much smaller in diameter than the tubing 12 and, if unsupported over a substantial length between the locking mechanism 24 and the mandrel 32, will sag relative to the centerline of the tubing 12. Sagging tends to shorten the effective length of the mandrel rod and may result in mislocation of the mandrel tooling relative to the shear plane S. As is apparent to persons skilled in supported shear technology and familiar with the disclosure of the aforesaid U.S. Pat. No. 6,123,003, the mandrel 32 has portions 32a and 32b which can displace radially relative to one another along a parting line to accommodate relative radial movement of the external shear tooling. To prevent catastrophic destruction of the mandrel during operation of the shear 14, it is necessary that the parting line between the portions 32a and 32b be precisely co-located with the shear plane S. Accordingly it is highly desirable to prevent sagging or flexing of the mandrel rod 22 which might disturb this critical relationship.

For this purpose, roller form 26 is integrated into the mandrel rod 22 by suitable mechanical connectors. In this case a conventional form 28 and a “qualifier” form 30 are also integrated into the rod 22, the former being near the locking mechanism 24 while the latter is closer to the mandrel 32. Each roller form 26 comprises a central machined steel body 34 which, as best shown in FIG. 3, is of hexagonal configuration. Straddling the body 34 are cam forms 36 and 38 which steer the leading edges of forwardly fed and rearwardly fed tubing onto the form 26 during in-feed and reverse-feed operations.

The body 34 has slot-like through apertures 40, 42 and 46 machined or otherwise suitably formed therein at axially spaced locations and in uniformly angularly spaced rotation. Each aperture or slot receives and provides rotational clearance for a hard rubber roller 46, 48 and 50 respectively. Each roller is supported on an axle rod or pin 52 which is secured across two parallel faces of the body 34 by slots and spring washers. The rollers have internal bushings to reduce friction.

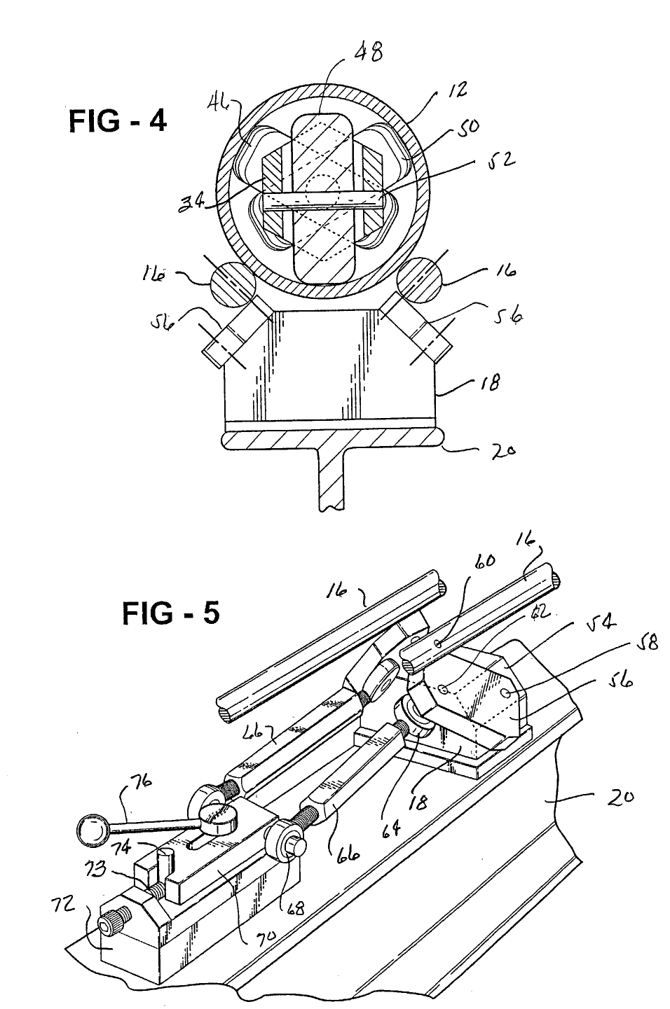

The axes of rotation of the rollers 46, 48 and 50 are all orthogonal to the longitudinal axis of the mandrel rod 22 and are angularly spaced from one another by equal angles of about 120° to provide three contact points with the interior surface of the tubing 12 as best shown in FIG. 4. As also shown in FIG. 4 the centerlines of the bearing pins 52 are not co-located with and do not pass through the centerline of the body 34. Instead the roller axes are off-set and the diameters of the rollers themselves are substantially smaller than the inside diameter of the tubing 12. Accordingly there is essentially only one contact point per roller as illustrated in FIG. 4.

Looking now to FIGS. 4 and 5, the structural associations between the roller support form 26, the tubing 12 and the rest bars 16 of the support table is illustrated. The support table comprises a series of longitudinally spaced blocks 18 which rest on the steel I-beam 20. Each block supports a pair of pivot plates 56 which are mounted on the beveled support surfaces 54 of the block 18. The pivot plates 56 are in turn pivotally connected to the rest table rods 16 as well as to turnbuckles 66 which can be used in combination with additional apparatus hereinafter described to vary the spacing between the rods 16 to accommodate tubing 12 of different diameters.

More specifically, pivot plate 56 is connected by a pivot 58 to the beveled surface 54 of block 18. A second pivot 60 interconnects the upper right hand corner of the block 56 to the bar 16. A third pivot 62 connects the swivel block 56 to the turnbuckle 66 by way of a ball joint 64. A second ball joint 68 connects the near end of the turnbuckle 66 to a slide block 70 the position of which relative to a base block 72 is controlled by a threaded rod 73 having a pin 74. A clamp 76 locks the block 70 in the selected position.

When the turnbuckles 66 are at maximum effective length, either by rotation thereof or by adjustment of the pin 74 relative to the base block 72 to the right as shown in FIG. 5, the pivot plates 56 are rotated relative to the opposite beveled faces 54 of the block 18 to a position which is more upright. This brings the top portions of the blocks 56 closer together to narrow the spacing between the rest bars 16. In the upright position the rest bars 16 would be a minimum distance apart which is appropriate to support smaller diameter tubing 12.

With turnbuckles moved from the upper right to the lower left as viewed in FIG. 5, the swivel plates 56 rotate toward a more supine position. This causes the pivot points 60 at the tops of the swivel blocks 56 to move apart, increasing the spacing between the rest bars 16 to accommodate tubing 12 of larger diameter. The ball joints 64, 68 allow the turnbuckles 66 to diverge.

As illustrated in FIG. 4, the rest bars 16 support the tubing 12 and the roller form 26 supports and centers the mandrel rod 22 relative to the centerline of tubing 12. Accordingly the mandrel rod 22 maintains a constant and predictable length between locking mechanism 24 and the shear plane S.

In a typical operation, the locking mechanism 24 is released or opened while the mechanism 25 remains closed. In this condition, tubing 12 is fed by drive mechanism 15 on to the rod 22 over the forms 8 and 26 toward the shear plane S. After the tubing 12 has passed the locking mechanism 24, the mandrel rod 22 is relocked in the proper position and the lock 25 is opened to allow the tubing 12 to reach the shear plane S of the shear 14. Assuming an automated feed mechanism 15 is used, the use of one or more roller forms 26 along the length of the mandrel rod 22 dramatically reduces the power requirements of the feed mechanism and substantially reduces the possibility of feed errors due to slippage.

It will be understood that the use of roller forms having hexagonal bodies and three roller is intended only for purposes of illustration. Roller forms with only one or two rollers are feasible but typically require a larger number of roller forms with closer spacing. The use of three rollers with a triangular arrangement of contact points is preferred.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. For use in an apparatus for performing a process on tubing which requires feeding the tubing over a mandrel support rod within the tubing:
a mandrel rod extending between an entry point and a processing point; a tubing support body attached to the mandrel rod between the entry point and processing point; and
at least one roller rotatably attached to the body for rotation about an axis perpendicular to the rod, said roller extending from said body for rolling contact with the inner surface of said tubing.

2. Apparatus as defined in claim 1 wherein the radius of the roller is smaller than the radius of the tubing and the center of the roller is attached to the body at a point which is offset from the geometric center of the tubing.

3. Apparatus as defined in claim 1 further including second and third rollers rotatably attached to the body for rotation about respective axes which are perpendicular to the rod and which are non parallel to each other and to the axis of rotation of said one roller.

4. Apparatus as defined in claim 3 wherein the angles between the axes of rotation of the three rollers are about 120°.

5. Apparatus as defined in claim 1 wherein said one roller is made of rubber.

6. In combination:
a rest for circular tubing and having an axis of tubing travel thereover;
a mandrel rod extending along the axis for tubing travel between an entry point and a processing point;
a body attached to the mandrel rod at a midpoint therealong between the entry point and the processing point; and
at least one roller rotatably attached to the body for rotation about an axis perpendicular to the rod and extending from said rod for rolling contact with an inner surface of a length of tubing.

7. Apparatus as defined in claim 6 wherein the radius of the roller is smaller than the radius of the tubing and the center of the roller is attached to the body at a point which is offset from the geometric center of the tubing.

8. Apparatus as defined in claim 6 further including second and third rollers rotatably attached to the body for rotation about respective axes which are perpendicular to the rod and which are non parallel to each other and to the axis of rotation of said one roller.

9. Apparatus as defined in claim 8 wherein the angles between the three rollers are all at least approximately 120°.

10. Apparatus as defined in claim 6 wherein said one roller is made of rubber.
